(19) United States
(12) Patent Application Publication
(10) Pub. No.: US 2021/0293654 A1
(43) Pub. Date: Sep. 23, 2021

(54) METHOD FOR MONITORING WATER SUPPLY NETWORK, WATER SUPPLY NETWORK, AND FAULT DETECTION SYSTEM

(71) Applicant: GROHE AG, Hemer (DE)

(72) Inventors: Bert DEPIERE, Wakkerzeel (BE); Robert VELTRUP, Duesseldorf (DE); Philip SPECK, Iserlohn (DE)

(73) Assignee: GROHE AG, Hemer (DE)

(21) Appl. No.: 17/206,642

(22) Filed: Mar. 19, 2021

(30) Foreign Application Priority Data
Mar. 20, 2020 (DE) 102020107780.7

(51) Int. Cl. G01M 3/28

(52) U.S. Cl. CPC G01M 3/2815

(57) ABSTRACT

A method for monitoring a water supply network (1) with a water distribution system (2), water channels (3) and a building's water connections (4) that includes at least the following steps: a) capturing at least one local water condition parameter in areas of a plurality of a building's water connections (4); b) capturing at least one central water condition parameter in at least one area of a water channel (3) or the water distribution device (2); c) comparing the water condition parameters with one another; and d) detecting at least one fault (5) with respect to at least one of the water channels (3) on the basis of the comparison according to step c).

The invention relates to a method for monitoring a water supply network comprising a (central) water distribution system, a plurality of water channels and water connections for buildings. The invention further relates to such a water supply network itself as well as to a fault detection system with which a fault can be detected with respect to such a water supply network.

The public infrastructure of the drinking water supply represents a combination of a large number of long-distance distribution lines and the so-called “last mile” piping, which is routed to the individual buildings or consumers.

With regard to such large water supply networks, it is not easy to detect whether the water supply network is damaged or the water quality is insufficient. This can, in particular, result in such damages and/or contaminations in the water supply network being detected late or being resolvable only under involvement of very intensive resources.

Of particular difficulty here is also the fact that the conditions in such a water supply network can vary greatly, especially due to the large number of consumers, a wide variety of consumption habits and/or a multitude of difficulties in reaching the buildings or the piping thereof.

Proceeding therefrom, it is the task of the present invention to, at least partially, solve the problems described with reference to the prior art. In particular, the intention is to propose a method for monitoring a water supply network, a water supply network as well as a fault detection system, with which undesired or unforeseen events regarding the water supply can be captured quickly and/or in a targeted manner, and, if necessary, measures can be taken for the rapid elimination of these faults.

These problems are solved with a method for monitoring a water supply network according to the features of patent claim 1. Advantageous further developments, including a water supply network and a fault detection system, are specified in the dependent patent claims. It should be noted that the features listed in the patent claims can be combined with one another in any technologically meaningful manner and be provided with further embodiments of the invention. The description, in particular also in connection with the illustrations, explains the invention and lists further embodiments.

The method described below for monitoring a water supply network contributes to this. The water supply network regularly has (at least) one water distribution system, a large number of water channels and water connections for the buildings.

A water distribution device may comprise a water reservoir, such as a lake, a tank or the like. The water distribution device also has means for providing water with a predeterminable characteristic for the water channels connected thereto, in particular with a predetermined water quality and/or a predetermined pressure. Pumps, valves, sensors, filters, etc. may also be provided for this purpose. The water is now delivered in a controlled manner from such a water distribution device into at least one water channel. Often, there exists a kind of central water channel from where a number of branches emanate; these are then used to form connection water channels that run the so-called “last mile” all the way to the building's water connection point. The water channels can be designed in the manner of a duct and/or with piping formed, for example, with metal pipes and/or plastic pipes. The water channels are designed to be pressure-resistant in such that, in particular, it is ensured that the water pressure set by the water distribution device decreases only to an acceptable extent via the water channels, for example, with a pressure difference of no more than 20%, wherein the pressure at the building water connection preferably deviates by less than 10% from the (centrally) provided pressure. In many cases, the building's water connection point for a (single) building, factory or other consumer unit is a central connection element, comprising, for example, a central shut-off valve. When a building has such a water connection point, it is possible in particular to supply water from the water channels to the building on an as-needed basis or to keep water available there. In this respect, such a water connection point for a building is set up in particular to allow or prevent the flow of water from the water channels to the building or to the consumer as necessary.

The monitoring method proposed herein includes at least the following steps:
a) capturing at least one local water condition variable in the area of a plurality of a building's water connection points;
b) capturing at least one central water condition variable in at least one area of a water channel or the water distribution device;
c) comparing the water condition parameters with one another;
d) detecting at least one fault point with respect to at least one of the water channels based on the comparison according to step c).

The sequence of steps a) to d) selected here must not necessarily be performed sequentially in this order; in many cases, it is often possible to overlap the steps at least in part or even to perform them simultaneously. In particular, it is also possible to repeat the steps associated with the method a different number of times, if necessary, also prior to a subsequent step being triggered.

The capturing of the at least one local water condition parameter according to step a) can be performed by calculation or by sensor. The water condition parameter can be determined directly from the water in the vicinity of a building's water connection point and/or calculated based thereon. In this instance, “local” means particularly that the water condition parameter is representative of the water condition in the vicinity of the building's water connection point, i.e., in particular in the area of the “last mile” and/or in the vicinity or exactly at the building's water connection point. In other words, it means, in particular, that a local water condition parameter is characteristic for the condition of the water supplied in the vicinity of the building's water connection point. In this context, rather than merely a single local water condition parameter being routinely captured in the area of a building's single water connection point, a plurality or multitude of the building's various water connection points are being captured simultaneously and/or successively. It is possible, for example, that the majority of all of the building's water connections points that belong to a water supply network and are connected via a (central) water channel are captured by this method.

According to step b), at least one central water condition parameter is being captured in the vicinity of a (central) water channel and/or of the water distribution device. Such central water condition parameter(s) can also be captured by way of sensors or by calculation. The central water condition parameter is particularly characteristic for the condition of the water that was introduced into the (central supply) water channel by the water distribution device a (briefly) beforehand. The central water condition parameter is determined particularly in an area before a (first) branch-off that is provided starting from the water channel and leading toward a water connection point of the building. It is particularly preferred that this central water condition parameter is captured in or at the outlet of the water distribution device.

The local and central water condition parameters captured at the various points in the water supply network are then compared with one another (step c)). It is possible that similar water condition parameters will be compared with one another, but it is also possible that different water condition parameters will be compared with one another, for example with a concordance list. In particular, the comparison can be automated and/or performed by way of calculation. It is possible that the comparison comprises the determination of a deviation of the water condition parameters in relation to one another, a temporal change of the water condition parameters in relation to one another or mutually and/or the exceeding of predefined limit values relative to the water condition parameters. If necessary, the results of the comparison can also be stored or made available for subsequent method steps.

Step d) now permits the detection of at least one fault point with respect to at least one of the water channels on the basis of the result from the comparison according to step c). A “fault” is to refer particularly to an area in which the predefined or expected water condition parameters fail to match the captured ones. A fault can include the entire water supply network or all water channels, but it is also possible to detect a single water channel or a single “last mile” piping assembly relating to exactly one water connection of the building as a fault. “Detecting” particularly refers to a general finding of a fault or fault situation, preferably a localization of a specific subarea with respect to the water channels of the water supply network. One possible outcome of step d) can be, for example, an output that the water or all water channels have not been set up as expected or that a local section of one or more of a few water channels is actually defective.

The water condition parameter can be at least one from the following group: pressure, flow, temperature, water quality, vibration. For example, it is possible to capture or determine the water pressure locally or centrally. It is equally possible to determine or capture the local and/or central water flow. It is possible to determine the water and/or ambient temperature in order to check the temperature impact, for example, on the detection of the water pressure. For the water quality, in particular, measures for analyzing the composition of the water, especially the ratio of biological substances, chemical substances, etc., can be used. It is equally possible to learn about the water condition by transmitting vibrations or sound through the water channels, wherein insights can be gained on the water condition based on the reflection of the vibrations or sound. It is possible that only one of these water condition parameters will be taken into account, but it is also possible that several or a plurality or all of these water condition parameters will be taken into account as part of the method proposed herein, with different water condition parameters being captured in different local areas or the central area, as appropriate. It is possible, for example on the basis of empirical knowledge, to correlate the captured local or central water condition parameters with one another in order to still allow for the respective water condition parameters to be compared with one another.

It is also being proposed that, during step(s) a) and/or b), the water flows through at least one of the building's water connection points. In other words, this means, in particular, that the method for monitoring the water supply network is performed “online”, i.e., during usual consumption via the building's water connection points. In such an “online” user situation, some of the building's water connections may be open, whereby water is being consumed, and/or other of the building's water connections may be closed, i.e., thus no consumption is occurring. In this situation, it is particularly advantageous, for example from empirical values, to apply the usual consumer behavior and thus to adjust or evaluate the local water condition parameters accordingly.

It is further possible that, during at least step a) or b), no water flows through at least one of the building's water connection points. In other words, this means in particular that, if applicable, step(s) a) and/or step b) are/is performed only if it can be determined momentarily that no water is flowing through either one, a plurality or all of the building's water connection points, i.e., that they are not consuming anything or are not drawing water from the water channels. It is possible to detect specifically such a condition, for example by appropriate measurements, or to select suitable specific times to perform the method, for example a holiday, night-time operation, etc., with the knowledge of the consumer behavior with respect to the water supply network.

It is particularly preferred that at least one of the building's water connections is closed before step a) or b). Within the scope of the method for monitoring, it can thus be provided that a specific instruction is sent to at least one, possibly a plurality or even all of the associated water connections points of the building to actively close the building's water connection(s). Such an instruction can, for example, take place automatically or electronically or by radio. This creates a static condition in the water supply network, which is particularly suitable for the analysis presented here and for detecting at least one fault. In particular, this approach offers the possibility to check the extent to which a central water status parameter changes over time relative to individual local water status parameters in closed water connections of the building.

It can also be provided that the captured water condition parameters from several steps a) and/or b) are taken into account in step d). For example, it is possible that the water condition parameters captured in step a) and/or b) are captured intermittently and that the captured local water condition parameters of the last partial steps are not used for a comparison according to step c) until a certain limit value or setpoint value is exceeded, reached or not reached.

According to a further development, it is being proposed that, depending on the result from step d), at least one shut-off valve is closed automatically. This means, for example, that in the event of a positive detection of a fault, a targeted command is given to a closing valve, which is part of the water supply network and will thus be automatically closed. The closing valve may be part of a building's water connection point. The closure valve may also be part of the water distribution system. It is possible that the closing valve is closed directly, but it is also possible, for example, for this to occur indirectly via a corresponding command from a control unit for the building's water connection point and/or its user(s).

Accordingly, it is also considered advantageous that an authorization request is sent to the users of the building's water connections prior to step a) and that the next steps of the method are not performed until after a confirmation from the user was received. In other words, this means, for example, that at a predefined time and/or a predetermined event, contact is first established with the building's water connection or its user(s) to find out whether the check method can be performed. This may include, for example, that the building's water connection is then closed and/or kept closed for a predefined time. This instruction to close or keep closed the building's water connection is not given until the user has issued a corresponding confirmation. Such a request or confirmation can take the form of an electronic data exchange, for example, via radio and/or mobile or stationary terminals and/or data acquisition systems. In other words, this can also mean that, in the absence of a corresponding confirmation, the implementation of the method proposed herein will be blocked. Such blockage may be in effect until a certain number of confirmations from users of building's water connections have been received. It is equally possible that this can be used to detect which of the building's water connections in the water supply network are definitely closed, which can be taken into account when evaluating the results of the method and thus improve the accuracy of the method.

According to a further aspect, what is being proposed here is a water supply network comprising a water distribution system, water channels and the building's water connections; furthermore, a fault detection system that is adapted to perform the method being proposed herein is provided for. The fault detection system may, in particular, comprise a data processing system and/or a network of data processing systems. In particular, the fault detection system is configured to determine, calculate or assign the local and central water condition parameters to the individual sections of the water supply network. Analysis units and algorithms may be included to enable the method to be executed.

According to yet another aspect, a fault detection system comprising a plurality of sensors for capturing at least one water condition parameter and means suitable to perform the steps of the method proposed herein are being proposed. In particular, said fault detection system may be equipped with data processing units, processors, computers, computing units, storage units, and electronic data links that allow the water condition parameters to be detected in various areas of the water supply network and then calculated and compared, if applicable, centrally.

It is particularly preferred that the fault detection system also has at least one radio unit for communication with at least one sensor, a closing valve, a building water connection or a mobile device for data transfer, with the mobile device also being set up for corresponding communication. In other words, this means in particular that data can be sent from the fault detection system to and/or received from at least one of the said components. In this context, data comprise measured values, messages, alarms, etc.

According to yet another aspect, a computer program is being proposed, comprising commands that prompt the fault detection system to perform the steps of the method proposed herein. In particular, the computer program may be a product that can be stored and executed on a storage medium.

The invention is particularly suitable for locating leakage sites with respect to such a water supply network or any water channel affected thereby.

It is possible, for example, to capture pressure data of a central water channel originating directly from the water distribution device, over a predefined time period or at specific time intervals. If necessary, this can also be done locally via corresponding capturing devices at the building's water connection points. By making available the various local and central water status parameters (here particularly the pressure), information about the flow status or the water status in the water supply network can be obtained in real time. For example, in the event where no water is momentarily expected to be flowing (all closing valves have been closed and a predefined pressure has been set in the water channels), a drop in pressure in the water supply network would indicate a leak. This information can be provided to the water distribution system to set up measures to repair or avert this condition.

It is further possible, in particular, that such an infrastructure test is initiated in such a way that first the operators or users of the building's water connections are notified in advance that such a test will be carried out at a predetermined time. The users may be informed or warned via an app, email, phone call, or the like, and then confirm the proposed time for the test. If an appropriate number of users subsequently agree to the test being performed and, if necessary, their main water connections are closed, the infrastructure or the leakproofness of the water channels can be checked quickly and precisely, enabling very precise localization of leakage points in particular.

The method proposed here, with the infrastructure components set up accordingly, make it possible to detect leaks at a very fast and precise point in time, thus avoiding the waste of potable water, enabling the reduction of repair costs and, if necessary, also reducing the holding costs for water to be provided.

Further, it is also possible, especially when using a water quality test, to quickly close a plurality of the building's water connections if a water contamination is detected. This can be achieved, in particular, by automatically controlling either predefined or all of the building's water connections that comprise a closing valve.

The invention and the technical environment are explained in more detail hereinbelow with reference to the illustrations. It should be noted that the figures show particularly preferred embodiments of the invention, but are not intended to be limited thereto. The illustrations are schematic. Identical components or parts are also generally provided with identical reference signs. Insofar as details of an illustration are not explicitly identified as mandatory in connection with another element of the illustration, these details may be combined with other details from other illustrations or from the general description. Shown are

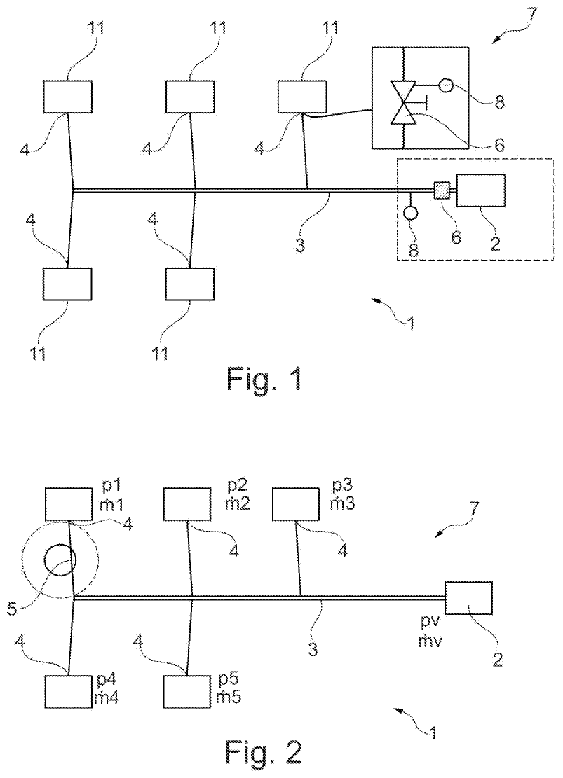

FIG. 1: an overview of a water supply network infrastructure,

FIG. 2: a case scenario, where pressure data are being compared in order to locate a leakage site,

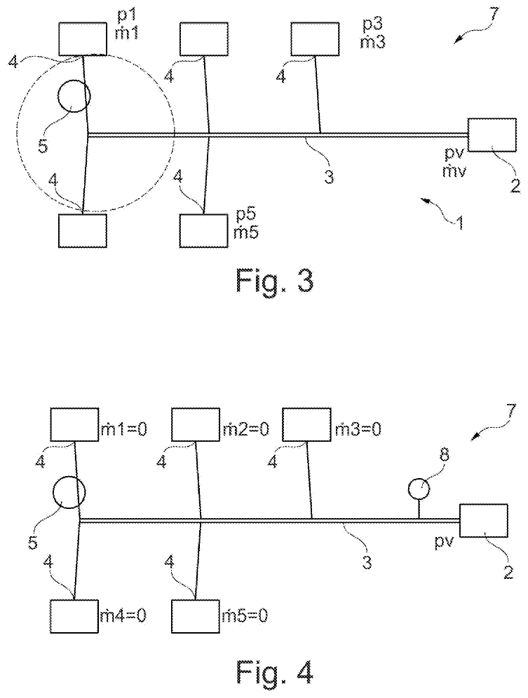

FIG. 3: a case scenario, also comparing pressure data in order to locate a leakage site, yet involving only a subset of the building's water connections,

FIG. 4: a case scenario where the infrastructure test is conducted with the building's water connections being closed,

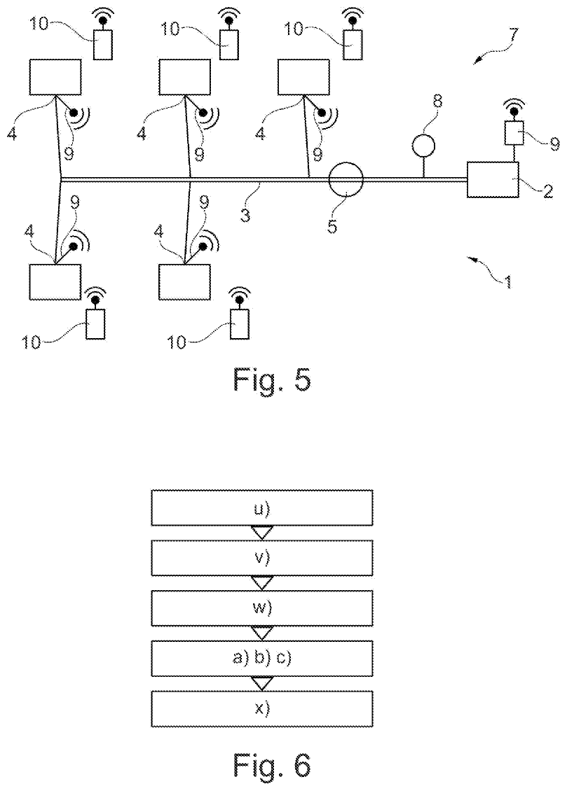

FIG. 5: a case scenario where a water quality problem is identified; and

FIG. 6: a possible flow routine for a monitoring method proposed here, where an additional user query takes place.

FIG. 1 schematically illustrates a water supply network (1) with a (single) water distribution device (2), which is shown on the right in FIG. 1. The water distribution device (2) comprises a closure valve (6) and a sensor (8). In particular, the sensor (8) is set up to determine at least one central water condition parameter.

Starting from the water distribution device (2), a (central) water duct (3), which then comprises various branches, runs to a plurality of the building's water connections (4). In the present example, five separate water connection of the building (4) are provided, each of which is assigned to its own water channel section starting from the central water channel (3), which individually leads to only one single water connection point of the building and can thus be referred to as a so-called “last mile.” The building's water connections (4) may be assigned, for example, to a building (11) in which a plurality of users or consumers are arranged, which, for simplicity's sake, are not shown here. It is possible that a plurality or all of the building's water connections (4) involved are implemented with a closing valve (6) and/or at least one sensor (8). The sensors (8) and the closure valves (6) may be part of a higher-level fault detection system, which may be set up in a data processing system (not shown here) or the cloud.

It is also worth mentioning that the building's water connection (4) can be designed with means for determining the water flow rate, temperature and, optionally if appropriate, with a water quality capturing or a device for measuring vibrations/sound.

For the water distribution device (2), at least one sensor for determining pressure, flow, temperature, vibration, sound or water quality may be provided in addition to the central closing valve (6).

FIG. 2 now illustrates the scenario where a leakage is identified in the vicinity of fault (5) outlined here. For example, it is possible that a pressure pv (for example, approx. 5.5 bar) is set via the water distribution device (2). Using the fault detection system (7), local water condition parameters are then captured in accordance with step a) for all of the building's water connections (4), which, in this case, are particularly comprising the flow rate \dot{m} and the pressure p. For example, it can be determined that the pressure p1=2 bar, \dot{m}1=0; p2=3 bar and \dot{m}2 is not equal to 0; p3=5.1 bar and \dot{m}3=0; p4=4 bar and \dot{m}4=0; and p5=5 bar and \dot{m}5=0. It is consequently self-evident that, for the building's closed water connections (4), approximately the same pressure would have to be present as per the settings selected in the area of the water distribution device (2). Only where a water flow is reached, for example when the building's water connection is open and/or there is a leakage, a larger pressure drop is to be expected. Here, for example, limit values can be specified, according to which a certain pressure drop can still be explained by normal consumer behavior, but a pressure drop exceeding said value indicates a leakage. In the present scenario, therefore, the greatest pressure drop is in area p1 when the building's water connection (4) is closed, which makes it possible to localize the site of the leakage or fault (5) in the area of this “last mile.”

The case scenario shown in FIG. 3 is set up in essentially the same way as just explained with reference to FIG. 2, but, here, the building's water connections (4) in the middle at the top and bottom left do not include any sensors; therefore, no measured values or water condition parameters can be locally captured there. If similar measured values are captured for the building's remaining water connections (4), as described hereinabove, this leads to a decrease in the localization accuracy, which is illustrated here by the dashed circle for the two sections on the left side of the water channel for the building's water connections (4) located furthest away. Nevertheless, this constellation also allows for the reliable and focused detection of the leakage.

FIG. 4 shows a case scenario where it has been ensured that all of the building's water connections are closed, i.e., there is currently no consumption. This can be set accordingly beforehand, whereby the pressure drop can then be measured via a specific specification of the pressure pv over time, for example by means of the sensor 8. For this purpose, specific routines and flow behavior of the water in the water channel 3 can be evaluated, which enables a very accurate detection of leakages, especially also in case of relatively small leakages (i.e., with a relatively low water loss).

FIG. 5 now illustrates the scenario where a water quality problem has been identified. Here, once again, the fault detection system (7) serves the purposes of identifying (e.g., centrally) a water contamination via the depicted sensor (8). The fault detection system (7) can then send warning signals or actuation commands, for example, via various radio units (9) on the water distribution system (2) or the building's water connections (4) and/or mobile devices (10) of the users, possibly resulting in the (partial) shutdown and/or flooding of the water supply network.

Finally, FIG. 6 illustrates a variant of the monitoring method that can be initiated only if the water supply network is in a predefined status. For example, it is possible that, according to u), a request is first sent to the users of the buildings or of the building's water connections to close or keep closed the associated closing valves for a predefined period of time.

This request, which can be transmitted by radio or by message, for example, then requires individual confirmation by the user (see step v)).

It may also be possible to initiate the monitoring method only after all or a certain number of confirmations have been received (step w)).

Now, if not already done, each closing valve of the building's water connections can be automatically set so that they are closed or remain closed. Once this has been ensured, then, for example, the here proposed method steps a), b) and c) will be performed.

After completion of the monitoring method, it is possible that the authorization to intervene or access data and/or the operation of the building's water connections (4) or their associated closing valves (6) and/or sensors (8) is interrupted again, which is denoted here by step x).

### LIST OF REFERENCE SIGNS

1 Water supply network

2 Water distribution device

3 Water channel

4 Building water connection

5 Fault

6 Closing valve

7 Fault detection system

8 Sensor

9 Radio unit

10 Mobile device

11 Building

p Pressure

\dot{m} Flow

1. A method for monitoring a water supply network (1) with a water distribution system (2), water channels (3) and the building's water connections (4), comprising at least the following steps:
a) capturing at least one local water condition parameter in areas of a plurality of the building's water connections (4);
b) capturing at least one central water condition parameter in at least one area of a water channel (3) or the water distribution device (2);
c) comparing the water condition parameters with one another;
d) detecting at least one fault (5) with respect to at least one of the water channels (3) based on the comparison according to step c)

2. The method of claim 1, wherein the water condition parameter is at least one of the following groups: pressure, flow, temperature, water quality, vibration.

3. The method according to claim 1, wherein, during at least step a) or b), water flows through at least one of the building's water connections (4).

4. The method according to claim 1, wherein no water flows through at least one of the building's water connections (4) during at least step a) or b).

5. The method according to claim 4, wherein at least one of the building's water connections (4) is closed at least before step a) or b).

6. The method according to claim 1, wherein the water condition parameters captured over several steps a) and b) are taken into account in step d).

7. The method according to claim 1, wherein at least one closing valve (6) is automatically closed depending on the result of step d).

8. The method according to claim 1, wherein, prior to step a), an authorization request is sent to users of the building's water connections (4) and the subsequent steps of the method are not performed until after a confirmation from the user was received.

9. A water supply network (1) with a water distribution device (2), water channels (3) and building water connections (4) as well as a fault detection system (7), set up for performing a method according to claim 1.

10. A fault detection system (7) comprising a plurality of sensors (8) for capturing at least one water condition parameter and means that are suitable for performing the steps of a method according to claim 1.

11. The fault detection system (7) according to claim 10, wherein, furthermore, at least one radio unit (9) is provided and set up for communication with at least one sensor (8), one closing valve (6), one water connection of the building (4) or one mobile device (10) for data transfer.

12. A computer program comprising commands that cause a fault detection system (7) comprising a plurality of sensors (8) for capturing at least one water condition parameter and means that are suitable for performing the steps of the method according to claim 1 to execute the steps of the method according to claim 1.
